(19) United States
(12) Patent Application Publication
(10) Pub. No.: US 2019/0289998 A1
(43) Pub. Date: Sep. 26, 2019

(54) RV-18 Cafe Table

(71) Applicant: Steven John Lysne, Nampa, ID (US)

(72) Inventor: Steven John Lysne, Nampa, ID (US)

(21) Appl. No.: 15/935,865

(22) Filed: Mar. 26, 2018

(51) Int. Cl. A47B 31/06; A47B 13/10; A47B 87/00; A47B 13/02; A47B 13/08; B29C 45/00

(52) U.S. Cl. CPC A47B 31/06; A47B 13/10; A47B 87/002; B29L 2031/448; A47B 13/081; B29C 45/0001; A47B 13/02

(57) ABSTRACT

The RV-18 Café Table is a small, round table for motor homes, recreational vehicles, and travel trailers that utilizes existing mounting hardware commonly found in motor homes, recreational vehicles, and travel trailers. The RV-18 Café Table is a design that does not presently exist in marketplace and is an improvement over existing motor home, recreational vehicle, and travel trailer furniture for some purposes. The RV-18 Café Table provides improved mobility in the interior of motor homes, recreational vehicles, and travel trailers and offers consumers a novel option for food preparation or other purposes. The RV-18 Café Table is constructed of solid surface and injection molded plastics and is affixed to hardware commonly found in motor homes, recreational vehicles, and travel trailers (i.e. an aluminum round cone base for a 3½ in. aluminum pedestal table leg).

### CROSS REFERENCE TO RELATED APPLICATIONS

Not applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The RV-18 Café Table pertains to the field of endeavors including the manufacture of furnishings for motor homes, recreational vehicles, and travel trailers (hereafter referred to as “RVs”). Currently the motor home, recreational vehicle, or travel trailer furniture (hereafter referred to as “RV” furniture) market is dominated by square or rectangular designs meant to maximize the surface area available for food preparation or other activities. While useful, this design neglects other attributes that make RV furniture practicable for other purposes. Space is limited in RVs and existing RV furniture does not allow ease of movement throughout the compartment. It can be difficult for individuals to maneuver around such furniture; this is particularly true if individuals are disabled or overweight. The RV-18 Café Table reduces mobility challenges and offers an alternative to large and cumbersome RV furniture.

### BRIEF SUMMARY OF THE INVENTION

The RV-18 Café Table is a small, round table for RVs that utilizes existing mounting hardware commonly found in RVs. The RV-18 Café Table is constructed of solid surface resins and injection molded plastics and is affixed to existing, commercially available hardware (i.e. round surface mount pedestal base for a 2¼″ aluminum or lightweight steel pedestal table leg).

### BRIEF DESCRIPTION OF THE SEVERAL VIEWS OF THE DRAWINGS

FIG. 1 shows the “top view” and “edge profile view” of the RV-18 Café Table.

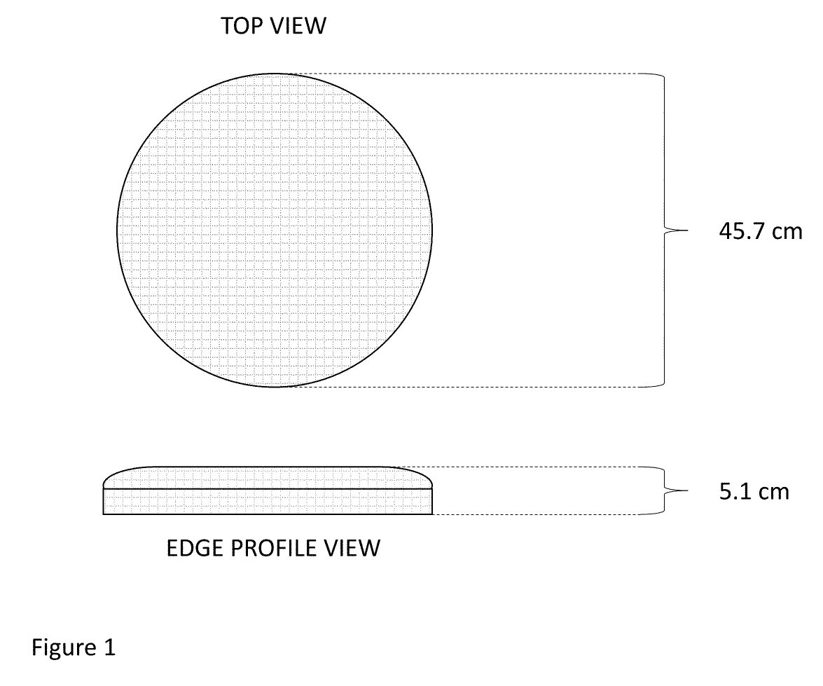

FIG. 2 shows the “bottom view” and “cut-away edge profile view” of the RV-18 Café Table.

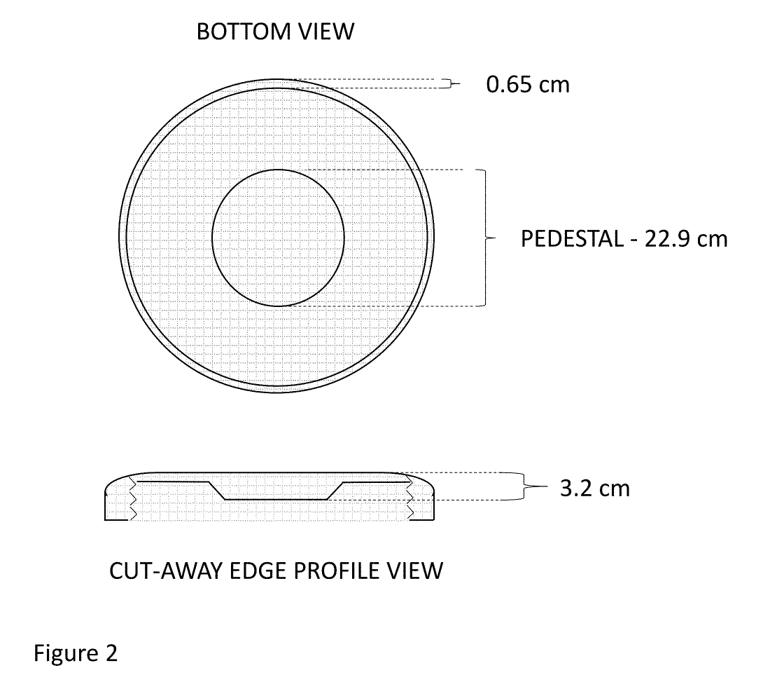

### DETAILED DESCRIPTION OF THE INVENTION

The RV-18 Café Table will be constructed of solid surface and injection molded plastics. Solid surfaces are those made of alumina trihydrate (ATH), acrylic, epoxy, and/or polyester resins and pigments and injection molded plastics are those made with plastic pellets containing “colorants” or other items to create patterns, sparkles, etc. in the finished product. Solid surfaces are purchased from manufacturers in sheets and then cut into pieces to assemble the café table. Thermoforming is the application of heat to shape the solid surface to create the edge profile or the “lip” of the café table. A press forces the solid surface into the correct shape and then the “mold” is trimmed and finished. Injection molding is a process where plastic pellets are fed into a hopper and barrel that melts the plastic and forces it into a mold where the plastic cools and is subsequently ejected.

The RV-18 Café Table is a new invention and is not commercially available for the RV furniture consumer. Today, RVs may have several styles of surfaces for cooking or food preparation but all are basically square or rectangular in design. None combine the space-efficiency, storage potential, and lightweight advantage of the proposed invention.

The RV-18 Café Table will be affixed to existing mounting hardware that is commonly used in RVs. Specifically, we will affix the RV-18 Café Table to a standard round cone table base (from Heng's Industries, Elkhart, Ind., USA) with a 2¼″ opening for a standard pedestal table leg.

1- the RV-18 Café Table is a new table design not currently available to the motor home, recreational vehicle, or travel trailer furniture consumer.
Description: Currently, motor home, recreational vehicle, or travel trailer furniture (hereafter referred to as “RV” furniture) is square or rectangular and is designed to maximize the surface area available for food preparation or other activities. While useful, this design neglects other attributes that make RV furniture practicable for other purposes.

2- the RV-18 Café Table is an improvement upon existing motor home, recreational vehicle, or travel trailer tables which are large and restrict the free movement of occupants inside.
Description: Space is limited in RVs and existing RV furniture does not allow ease of movement throughout the compartment. It can be difficult for individuals to maneuver around such furniture; this is particularly true if individuals are disabled or overweight. The RV-18 Café Table reduces mobility challenges and offers an alternative to large and cumbersome RV furniture.

3- the RV-18 Café Table is a round table constructed of solid surfaces or injection molded plastics.
Description: Solid surfaces are those made of alumina trihydrate (ATH), acrylic, epoxy, and/or polyester resins and pigments and injection molded plastics are those made with plastic pellets containing “colorants” or other items to create patterns, sparkles, etc. in the finished product. Solid surfaces and injection molded plastics have different characteristics and we claim the invention of the RV-18 café table in both materials in this application: Solid surfaces are heavier and confer to end product a different “feel” to the consumer; they are also more expensive to produce thus resulting in a higher-end product. Injection molded plastics by contrast are lighter, less expensive to produce, and easier to move. The RV-18 Café Table will be constructed of both solid surfaces and injection molded plastics to meet the different demands and needs of consumers.

4- the RV-18 Café Table is to be used with existing mounting hardware commonly found in RVs.
Description: Modern RVs have just a few different mechanisms for securing RV furniture to the floor or walls of the RV. The RV-18 Café Table is designed to utilize components already commercially available to consumers. Specifically, we will affix the RV-18 Café Table to a standard round cone table base (from Heng's Industries, Elkhart, Ind., USA) with a 2¼″ opening for a standard pedestal table leg.

5- the RV-18 Café Table measures between 40 cm and 50 cm in circumference when viewed from the top and is between 3 cm and 6 cm in thickness when viewed from the side.
Description: Consumers desire choices and the RV-18 Café Table will be available in larger or smaller circumferences and thicknesses in an effort to match our unique design attributes with user preferences.

6- the RV-18 Café Table is constructed of solid surfaces or injection molded plastics measuring only between 0.5 cm and 1.5 cm in thickness to both confer rigidity and minimize weight of the product.
Description: RV furniture must balance stylistic considerations with practical constraints such as product weight. Stylistic considerations have resulted in the appearance of a sturdy, thick table such as in our homes. The RV-18 Café Table has an “edge profile” between 3 cm and 6 cm when viewed from the side to give the stylistic impression of a heavy and sturdy kitchen table however it is constructed of materials only 0.5 cm to 1.5 cm in thickness (see cut-away edge profile view). We achieve the appearance of a much thicker table surface (see edge profile view) by an enlarged edge profile measuring between 3 cm and 6 cm.

7- the RV-18 Café Table has a reinforced center pedestal to provide stability and a point of attachment for existing mounting hardware commonly found in RVs.
Description: The center pedestal of the RV-18 Café Table measures 22 cm to 24 cm in diameter (see bottom view) and between 2 cm and 4 cm deep (see side cut-away view). The pedestal has two purposes. The first purpose is for mounting the standard round cone table base (from Heng's Industries, Elkhart, Ind., USA). The 2-4 cm pedestal will allow holes to be drilled and mounting hardware to be affixed to the bottom of the table. The second purpose is for table stability. The center pedestal will be thicker, and therefore heavier, than the construction materials at the perimeter of the table. This will create a table with a large percentage of its mass in the geometric center of the top, immediately above the structural support element. This design will make the RV-18 Café Table more stable while maintaining its lightweight attribute.
